(19) United States
(12) Patent Application Publication
(10) Pub. No.: US 2022/0003715 A1
(43) Pub. Date: Jan. 6, 2022

(54) ULTRASOUND SCANNING SYSTEM FOR IMAGING AN OBJECT

(71) Applicant: DolphiTech AS, Gjøvik (NO)

(72) Inventors: Eskil Skoglund, Gjøvik (NO); Øystein Knauserud, Gjøvik (NO); Fredrik Lingvall, Gjøvik (NO); Yngve Raudberget, Gjøvik (NO); Øyvind Syljuasen, Gjøvik (NO); Bjorn-Harald Thirud, Gjøvik (NO)

(21) Appl. No.: 17/288,898

(22) PCT Filed: Oct. 25, 2019
(86) PCT No.: PCT/EP2019/079195

§ 371 Date: Apr. 26, 2021

(30) Foreign Application Priority Data
Oct. 26, 2018 (GB) GB 1817502.6

(51) Int. Cl. G01N 29/04; G01N 29/06; G01N 29/26; G01N 29/265

(52) U.S. Cl. CPC G01N 29/043; G01N 29/0654; G01N 2291/106; G01N 29/265; G01N 2291/044; G01N 29/262

(57) ABSTRACT

A scanning system for imaging an object, the scanning system comprising: a scanning apparatus configured to transmit ultrasound signals towards an object and to receive ultrasound signals reflected from an object whereby data pertaining to an internal structure of an object can be obtained; a location sensor for sensing a location of the scanning apparatus; and an instruction unit arranged to provide instructions to a user of the scanning system in dependence on the sensed location.

### CROSS-REFERENCE TO RELATED APPLICATIONS

The present application is the national stage entry of International Patent Application No. PCT/EP2019/079195, filed on Oct. 25, 2019, and claims priority to Application No. GB 1817502.6, filed in the United Kingdom on Oct. 26, 2018, the disclosures of which are expressly incorporated herein in its entirety by reference thereto.

### FIELD OF THE INVENTION

The present invention relates to a scanning system for imaging an object. In particular it relates to a scanning system for imaging structural features below an object's surface. The scanning system may be particularly useful for imaging sub-surface material defects such as delamination, debonding and flaking.

### BACKGROUND

Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc. Therefore, there is a need for a sensing apparatus that is capable of performing well in a wide-range of different applications.

### SUMMARY

According to an aspect of the present invention, there is provided a scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
an instruction unit arranged to provide instructions to a user of the scanning system in dependence on the sensed location.

The instructions to the user may comprise an instruction to one or more of: re-orient the scanning apparatus at the sensed location; perform a further scan at the sensed location; and move the scanning apparatus to a new location. The instruction to perform a further scan at the sensed location may be provided to the user in dependence on a measure of quality associated with one or more previous scan. The measure of quality may comprise a measure of the signal to noise ratio of data obtained during the one or more previous scan.

The scanning system may comprise an indicator for indicating to the user a direction in which to move the scanning apparatus.

The instructions to the user may comprise an instruction to move the scanning apparatus so as to image an internal volume of an object from a different location.

The location sensor may comprise one or more of a local positioning system and a remote positioning system. The local positioning system may comprise one or more of a rotational encoder and an inertial measurement unit. The remote positioning system may comprise an emitter provided at the scanning apparatus and a plurality of detectors located remotely from the scanning apparatus. The emitter may emit electromagnetic radiation and the detectors may be configured to detect the emitted radiation.

The location sensor may be configured to combine data from a plurality of positioning systems. The location sensor may be configured to combine the data from the plurality of positioning systems in dependence on a measure of accuracy of each positioning system.

The scanning system may further comprise a configuration unit arranged to configure the scanning apparatus in dependence on the sensed location. The configuration unit may be arranged to select configuration data for configuring the scanning apparatus, and to send the selected configuration data to the scanning apparatus so as to configure the scanning apparatus. The configuration data may comprise data relating to a physical reconfiguration of the scanning system, and the instructions to the user may comprise an instruction to change the physical configuration of the scanning system.

According to another aspect of the present invention, there is provided a scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
an image generation unit configured to generate an image representative of an object in dependence on the obtained data and the sensed location of the scanning apparatus at which that data was obtained.

The image generation unit may be configured to: detect a feature in first scan data obtained at a first sensed location; detect a feature in second scan data obtained at a second sensed location; determine, based on the first and second sensed locations that the detected feature in each of the first scan data and the second scan data is the same feature; and combine the first scan data and the second scan data in dependence on the determination.

According to another aspect of the present invention, there is provided a scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
a processor configured to determine an estimate of the location of the scanning apparatus in dependence on the sensed location and the obtained data.

According to another aspect of the present invention, there is provided a scanning system for imaging an object, the scanning system comprising:
a scanning apparatus configured to transmit ultrasound signals towards an object and to receive ultrasound signals reflected from an object whereby data pertaining to an internal structure of an object can be obtained, the scanning apparatus having a non-planar configuration;
a sensor for sensing the non-planar configuration of the scanning apparatus; and
a configuration unit arranged to configure the scanning apparatus in dependence on the sensed non-planar configuration.

The sensor may comprise one or more of a strain gauge and an encoder wheel. The scanning system may further comprise a location sensor for sensing a location of the scanning apparatus, and the configuration unit may be arranged to configure the scanning apparatus in dependence on the sensed location.

According to another aspect of the present invention, there is provided a scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
a processor configured to combine data obtained from a plurality of scans in dependence on the sensed location of the scanning apparatus in respect of each of the plurality of scans.

The location sensor may comprise a plurality of positioning systems; the processor may be configured to combine data obtained from the plurality of scans in dependence on a measure of accuracy of each of the plurality of positioning systems.

The location sensor may comprise a further positioning system configured to determine a location in one frame of reference and to transform that determined location into another frame of reference. The further positioning system may be configured to determine a transformation for transforming the determined location into the other frame of reference in dependence on one or more marker in an image captured by the scanning system.

The scanning system may be configured to intersperse a plurality of scans of a first scan type with at least one scan of a second scan type. The scanning system may be configured to regularly intersperse the plurality of scans of the first scan type with the at least one scan of the second scan type.

According to another aspect of the invention there is provided a method of scanning an object with an ultrasound scanning apparatus with interspersed scanning modes, the ultrasound scanning apparatus comprising an array of transducer elements and being configured to transmit, using the transducer elements, ultrasound signals towards an object and to receive ultrasound signals reflected from an object whereby data pertaining to an internal structure of an object can be obtained, the method comprising:
transmitting a first number of ultrasound pulses of a first type using a first set of transducer elements; and
transmitting a second number of ultrasound pulses of a second type, different to the first type, using a second set of transducer elements.

The method may comprise transmitting the second number of ultrasound pulses of the second type on determining that: the scanning apparatus has moved by a multiple of a predefined distance; or a predefined number of ultrasound pulses of the first type have been transmitted.

At least one of the first number of pulses and the second number of pulses may be selected in dependence on one or more of an object under test, a material of an object under test, a thickness of an object under test, a feature of an object under test, a speed of movement of the scanning apparatus, a size of the array, a shape of the array and a transducer element size.

The predefined distance may be selected in dependence on one or more of an object under test, a material of an object under test, a thickness of an object under test, a feature of an object under test, a speed of movement of the scanning apparatus, a size of the array, a shape of the array and a transducer element size.

The first set of transducer elements may differ from the second set of transducer elements.

Any one or more feature of any aspect above may be combined with any other aspect. These have not been written out in full here merely for the sake of brevity.

### BRIEF DESCRIPTION OF THE FIGURES

The present invention will now be described by way of example with reference to the accompanying drawings. In the drawings:

FIG. 1 shows a device for imaging an object;

FIG. 2 shows an example of a scanning apparatus and an object;

FIG. 3 shows an example of the functional blocks of a scanning apparatus;

FIG. 4 shows an example of scanning an object at an angle to the vertical;

FIG. 5 shows an example of an indicator on a scanning apparatus;

FIG. 6a shows an example of scanning an object at two locations;

FIG. 6b shows another example of scanning an object at two locations;

FIG. 7 shows a method of operating a scanning apparatus;

FIG. 8 shows a method of generating an image;

FIG. 9 shows a method of scanning an object in dependence on a measure of quality associated with a scan;

FIG. 10 shows a method of estimating location;

FIG. 11 shows a method of configuring a scanning apparatus;

FIGS. 12a and 12b show examples of a transducer module;

FIGS. 13a and 13b show examples of a transducer module and coupling;

FIG. 14 shows two transducer modules imaging a subsurface feature;

FIG. 15a shows an example of a transducer matrix comprising orthogonal conducting lines; and

FIG. 15b shows transducer elements of the matrix of FIG. 15a grouped into a plurality of groups;

FIG. 16a shows an example method of scanning an object with interspersed scanning modes;

FIG. 16b shows another example method of scanning an object with interspersed scanning modes;

FIG. 16c shows another example method of scanning an object with interspersed scanning modes;

FIGS. 17a and 17b show representations of an object.

### DETAILED DESCRIPTION

A scanning apparatus may gather information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected. An example of a piezoelectric material which can be used in an ultrasound transducer is polyvinylidene fluoride (PVDF).

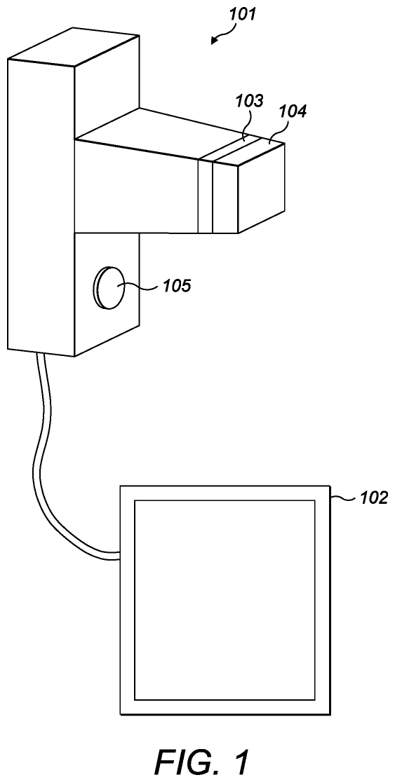

An example of a handheld device, such as a scanning apparatus of a scanning system described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. A dry coupling layer offers a number of advantages over other imaging systems, which tend to use liquids for coupling the ultrasound signals. This can be impractical in an industrial environment. If the liquid coupler is contained in a bladder, as is sometimes used, this makes it difficult to obtain accurate depth measurements which is not ideal for non-destructive testing applications. The coupling layer need not be provided in all examples.

The matrix array 103 is two dimensional so there is no need to move it across the object to obtain an image. A typical matrix array might be 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. The most appropriate pulse shape may depend on the type of structural feature being imaged and where it is located in the object. The operator can view the object at different depths by adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

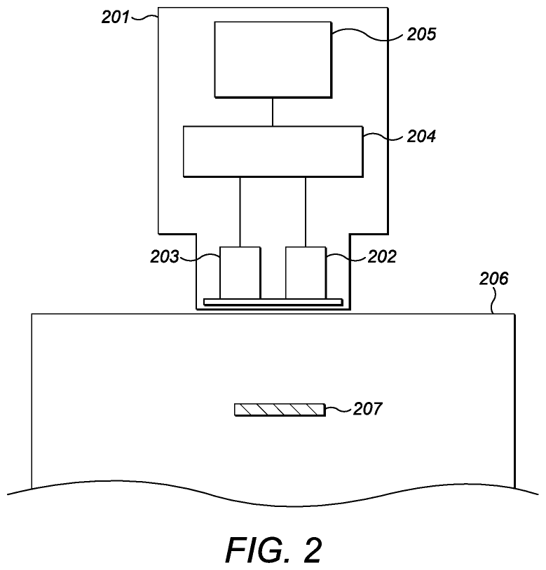

A scanning apparatus for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

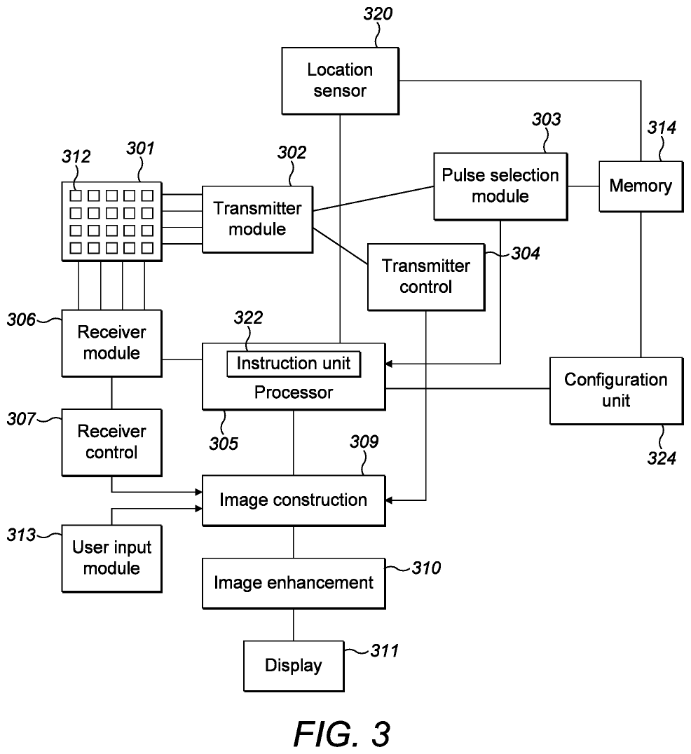

An example of the functional blocks comprised in one embodiment of the apparatus are shown in FIG. 3.

In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

The location of the scanning apparatus can be sensed by a location sensor 320. The location sensor 320 may comprise one or more positioning system. The location sensor may be coupled to the processor and to the memory 314. The system may be configured so that locations sensed by the location sensor can be stored in the memory and are accessible to the processor.

The system may comprise an instruction unit arranged to provide instructions to a user of the scanning system. The instruction unit may be configured to provide the instructions to the user in dependence on a location sensed by the location sensor. The processor 305 may comprise the instruction unit 322. In some examples, the instruction unit may be configured to cause display of the instructions on an indicator, such as a display. The indicator on which the instructions are caused to be display may be local to the scanning apparatus. For example the scanning apparatus may comprise the indicator. The indicator may be remote from the scanning apparatus, for example comprised in a PC to which the scanning apparatus may be coupled.

A configuration unit may be provided which is arranged to configure the scanning apparatus in dependence on the sensed location. The configuration unit 324 may be coupled to the processor 305 and to the memory 314. The configuration unit suitably has access to sensed locations via the memory, but in some examples may additionally or alternatively couple directly to the location sensor 320.

The location may comprise position and/or orientation information relative to a desired frame of reference. The frame of reference can comprise a workbench on which an object to be imaged is located, a room or hangar in which an object to be imaged is located, an object to be imaged (for example a car or an aeroplane) or a part of the object to be imaged (for example a wing section of an aeroplane).

The location can be determined in 2D (such as over a 2D surface of an object, including a curved, or otherwise non-planar surface) and/or in 3D. Location can be determined in up to six degrees of freedom, for example the location may comprise a position along each of an x, y, and z axis and a rotation about each of the x, y, and z axes.

The location sensor is preferably configured to determine the location of the scanning apparatus relative to the frame of reference by generating location data at the scanning apparatus itself, by monitoring the location of the scanning apparatus remotely from the scanning apparatus, or some combination of these approaches.

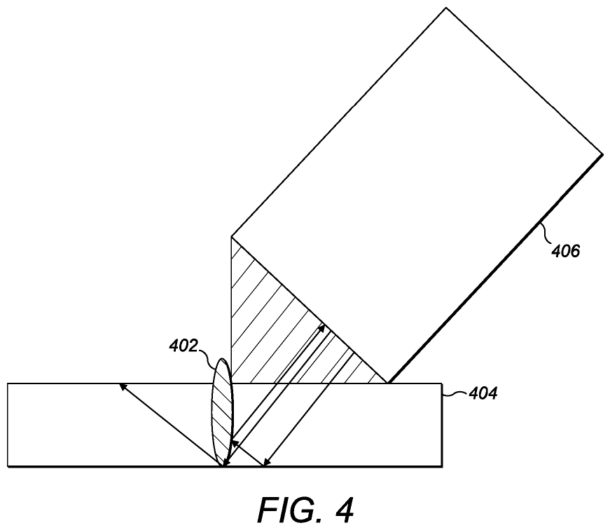

The instructions to the user may comprise an instruction to re-orient the scanning apparatus at the sensed location. This can ensure that the scanning apparatus is optimally applied to the known orientation of the object, such as an aeroplane part, at that sensed location. The system may have knowledge of a feature, such as a defect or a repaired defect, in the object adjacent the location of the scanning apparatus, and can instruct the user to apply the scanning apparatus so as to optimally obtain image data from the object. In an example illustrated in FIG. 4, a weld 402 is shown in an object 404. The location of the weld may be known. The system may determine that it is appropriate to scan the object adjacent the weld at an angle to the vertical (with respect to the orientation of FIG. 4). In the illustrated example, the desirable scan direction is at an angle of approximately 45 degrees to the vertical. Locating a scanning apparatus 406 in this location enables additional data to be obtained relating to the weld than if the scanning apparatus was simply kept vertical adjacent the weld.

In some examples, the system is configured to detect wear in the scanning apparatus, or in a portion of the scanning apparatus, in dependence on the orientation of the scanning apparatus. Knowledge of the location at which the scanning apparatus is located permits a determination of an orientation of the object surface at that location. Based on the orientation of the scanning apparatus, the angle of the scanning apparatus relative to the object surface can be determined. Where this angle is, say, 2-3 degrees different from the expected angle, it may be indicative that the surface of the scanning apparatus, for example the surface of the transducer or of the coupling, is worn. In dependence on determining that a portion of the scanning apparatus is worn, the system can prompt the user to replace the worn part. This can ensure that the system operation remains within desired tolerances. The angle at which the system determines that a part is worn can be preselected and/or user-configurable.

In some examples the instructions to the user comprise an instruction to re-scan the object, e.g. to perform one or more further scan at the same location. Thus the user may be prompted to scan over an area of the object that has already been scanned by the scanning apparatus.

The instruction to re-scan the object may be provided to the user in dependence on a measure of quality associated with a previous scan, or a measure of quality associated with a combination of previous scans. The measure of quality may comprise a measure of the signal to noise ratio of data obtained during the previous one or more scan.

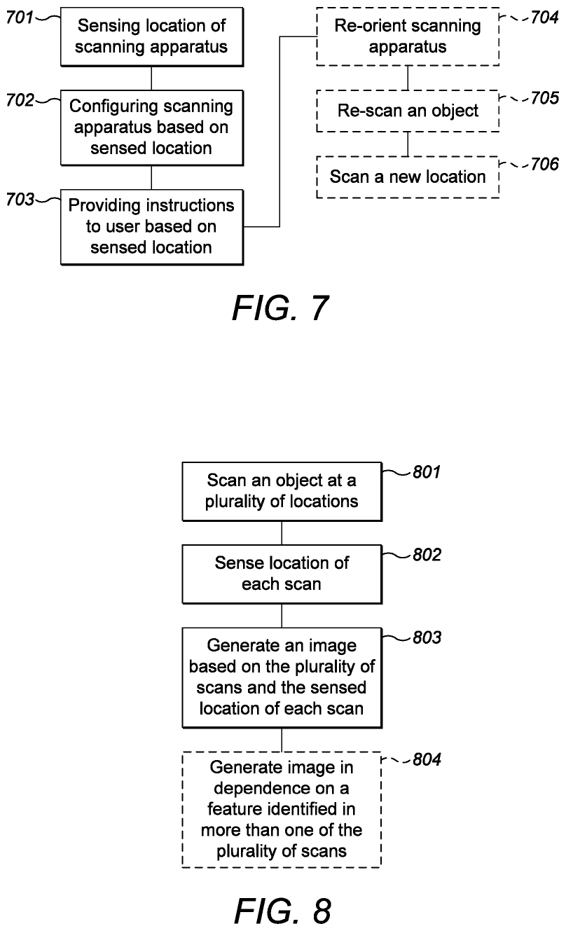

Referring to FIG. 7, a method can comprise sensing the location of the scanning apparatus 701. Configuration of the scanning apparatus can be performed in dependence on the sensed location 702. Instructions can be provided to a user in dependence on the sensed location 703. Optionally, the method may further comprise one or more of providing an instruction to re-orient the scanning apparatus 704, to re-scan an object 705, for example a particular location on an object, and to scan a new location on an object 706.

Once obtained, the processor can analyse data from a scan. The analysis can reveal information relating to the quality of the data. Such information can take the form of a measure of quality associated with data obtained from one or more scan which might be a numeric value assigned to the data in dependence on the processing of the data. The processing of the data may comprise processing the data against known metrics, such as a threshold. The measure of quality can comprise the signal to noise ratio (SNR) of the data.

Suitably, data from a single scan can be processed to generate a measure of quality for that data. More than one scan may be obtained in respect of a given scan area of the object's surface, or a given scan volume of the object. These multiple scans may be combined, for example by the processor. In some examples, the data from the multiple scans may be averaged. Other combination techniques would be apparent to the skilled person. Where the location of the scanning apparatus changes between scans, the processor is suitably configured to access the sensed location of the scanning apparatus at which the scan was performed, and to process the scans in dependence on that sensed location or those sensed locations.

For example, where the scanning apparatus takes a scan at one location on an object's surface, then moves laterally to another scan location which partially overlaps with the first scan location, the processor can be configured to combine data from the two scans in respect of the overlapping area on the surface (and the overlapping volume of the scans).

Referring to FIG. 8, a method may comprise scanning an object at a plurality of locations 801. The location of the scanning apparatus in respect of each scan can be determined 802. An image can be generated in dependence on the plurality of scans and the sensed locations 803.

As a greater number of scans of a given scan area or scan volume are obtained and combined by the processor, the quality of the resulting data is likely to improve. For example, where data from a series of scans is combined, the SNR is likely to increase.

In some examples, the scanning system is configured such that a user is instructed to obtain data that satisfies a given measure of quality, for example a SNR threshold. The processor is preferably configured to access a memory at which a measure of quality of data obtained by the scanning apparatus can be stored, and at which one or more desired measure of quality can be stored. For example, the current SNR of the data (or combined data) can be stored at the memory. The desired SNR threshold can be stored at the memory. The processor is suitably configured to compare the current measure of quality with the desired measure of quality to determine whether the measure of quality is satisfied. If the measure of quality is satisfied, for example where the current SNR equals or exceeds the SNR threshold, the scanning system can prompt the user to move on to another scan location. Where the measure of quality is not yet satisfied, for example where the current SNR is lower than the SNR threshold, the scanning system can prompt the user to re-scan the location, thereby to obtain additional data and improve the SNR.

This approach enables an efficient use of the scanning system. In situations where better quality data can be obtained from each scan, a lower number of scans can be performed to satisfy the desired measure of quality. In situations where the data quality from each scan is lower, a greater number of scans can be performed so as to ensure that the measure of quality is satisfied. The present approach thus enables a dynamic varying of the number of scans performed in dependence on the obtained data, for example on the measure of quality obtained from the data. This dynamic variation of the number of scans can mean that scans are not performed unnecessarily (where the measure of quality is already satisfied), which can save time. The dynamic variation of the number of scans can mean that the required data to ensure that the measure of quality is satisfied is obtained whilst the scanning apparatus is in place adjacent the object, and avoids needing to set up the scan at the same location at a later time. This approach is also likely to help reduce the overall time required to obtain the desired scans, in particular where that scan location is hard and/or time-consuming to access.

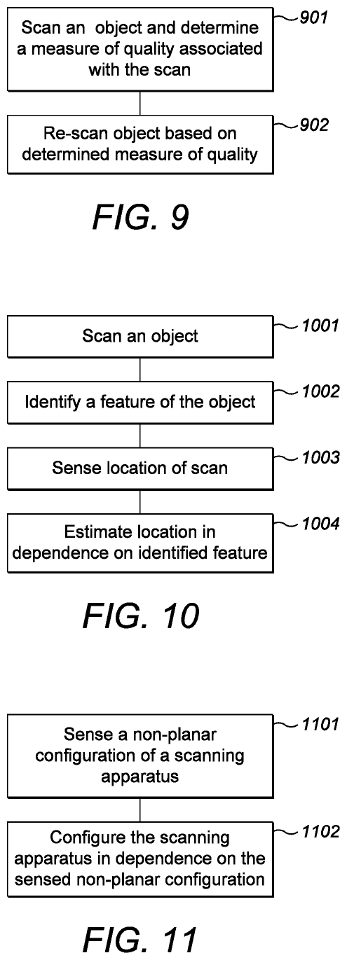

Referring to FIG. 9, a method may comprise scanning an object using a scanning apparatus, and determining a measure of quality associated with the data obtained from the scan 901. A determination can be made as to whether or not to re-scan the object at the same location in dependence on the determined measure of quality 902.

The scans of a given area need not be performed sequentially with the scanning apparatus remaining in a fixed location adjacent that area. It is possible for the scanning apparatus to be placed at different locations on the object, and/or to be moved across the object. The location sensor is configured to sense the location of the scanning apparatus in respect of each scan. The processor can be configured to use this sensed location, together with the data from the scan, to combine that data with data from other scans.

In some examples, the instructions to the user may comprise an instruction to move the scanning apparatus to a new location. The processor may detect a feature in the object, and may instruct the user to move the scanning apparatus in a direction so as to explore the detected feature. For example, where a feature has a longitudinal extent in an x-direction, the scanning system can instruct the user to move along the x-direction once the feature has been detected, so as to ensure that the feature is characterised along its length.

In some examples, the user may be instructed to move the scanning apparatus away from a predetermined scan pattern, such as to determine the longitudinal extent of a detected feature. The instructions to the user may comprise an instruction to move back towards the predetermined scan pattern.

The scanning system may comprise an indicator for indicating to the user a direction in which to move the scanning apparatus. The indicator can comprise a display. The indicator can comprise a matrix of lights, which can light up in accordance with the direction in which the scanning apparatus is to be moved. The indicator may comprise a series of arrows, for example arrows pointing up, down, left and right. Additionally or alternatively, arrows indicating other directions can be provided.

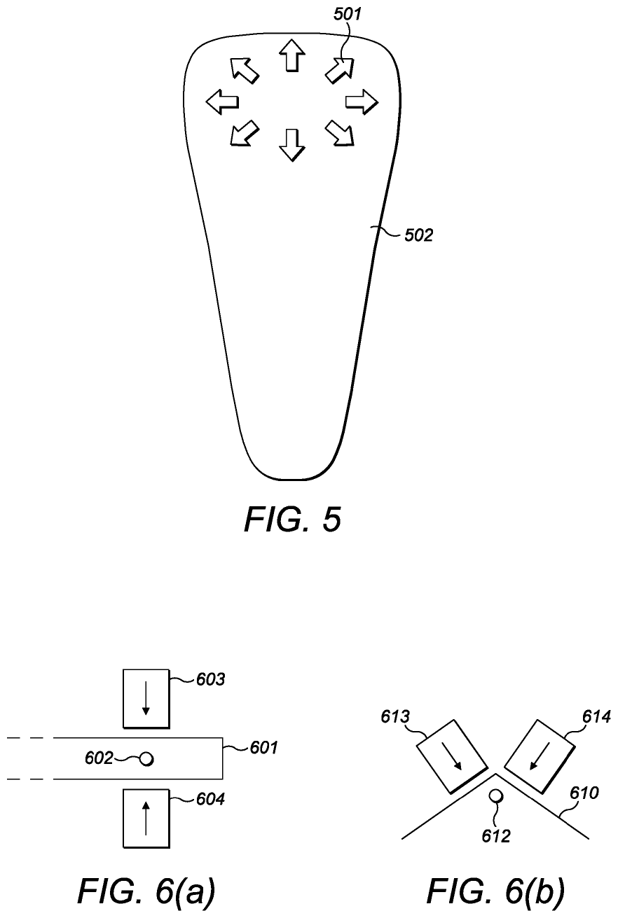

The scanning apparatus can comprise the indicator. An example of a scanning apparatus comprising an indicator is illustrated in FIG. 5. FIG. 5 shows arrows 501 located on the scanning apparatus 502. The arrows may be at least partly translucent and may be provided so as to cover respective lights. Illumination of the lights will cause the corresponding arrow to become illuminated, indicating a direction to the user.

Thus the user of the scanning apparatus can be informed of the direction in which to move the scanning apparatus without needing to refer to a remote indicator. This can be particularly useful where the scanning apparatus is being used at a distance from the remainder of the scanning system. This might be the case where, for example, the object being scanned is large and the user mounts a ladder to scan a relatively high part of the object. It would be inconvenient if the user had to return to the bottom of the ladder to find out in which direction the scanning apparatus should be moved. Providing the indicator at the scanning apparatus is therefore more convenient.

In some examples the indicator may be provided on the tablet computer to which the scanning apparatus can be coupled.

The instructions to the user may comprise an instruction to move the scanning apparatus so as to image an internal volume of the object from a different location. For example, where a surface such as an upper surface of an object is being scanned by the scanning apparatus, and a feature such as a defect is detected within the scanned volume, the system can instruct the user to scan the object from a reverse (in this example, a lower) surface. This can provide additional detail on the detected feature, enabling a more accurate characterisation of that feature.

The surface from which the user is instructed to re-scan the scanned volume need not be opposite to the initial scanning surface. In some examples, a feature may be detected near a corner and, following an initial scan of the corner from one side, the scanning system can instruct the user to scan the corner from the other side. This combination of scanning directions enables the system to obtain more accurate data relating to features detected within the object.

Examples of scanning an object from different locations are illustrated in FIGS. 6a and 6b. FIG. 6a shows an object 601 comprising a sub-surface feature 602. The object can be scanned by a scanning apparatus in one location (indicated at 603; the arrow indicates the direction of the scan). The object can be re-scanned by a scanning apparatus in another location, facing the first scanning location (indicated at 604; the arrow indicates the direction of the scan). Both scans will image the sub-surface feature 602, enabling a more accurate image of that feature to be generated.

FIG. 6b shows an object 610 comprising a sub-surface feature 612. The object can be scanned by a scanning apparatus in one location (indicated at 613; the arrow indicates the direction of the scan). The object can be re-scanned by a scanning apparatus in another location, near to the first location and angularly offset therefrom (indicated at 614; the arrow indicates the direction of the scan). Both scans will image the sub-surface feature 612, enabling a more accurate image of that feature to be generated.

In some examples, the location sensor comprises a local positioning system. The local positioning system is configured to generate location data at the scanning apparatus. The location data generated by the local positioning system may be absolute location data, e.g. data indicating the location of the scanning apparatus relative to the frame of reference, and/or relative location data, e.g. data relative to a known location. Relative location data can, in some examples, comprise an indication of a distance through which the scanning apparatus has been moved from a known location, and/or an angle through which the scanning apparatus has been rotated from a known orientation. The relative location data is useful when used in combination with absolute location data (for example a known starting location and/or a known starting orientation) to determine how the scanning apparatus is moved. The relative location data can, in some examples, be used to increase the accuracy of the location determination compared to using only the absolute location data.

The local positioning system may comprise a rotational encoder. The rotational encoder may include a ball for moving over a surface of the object, and one or more encoder coupled to the ball to detect rotation of the ball in at least one direction. The rotational encoder may comprise two encoder wheels (or cylinders) configured to rotate about respective axes that are angularly offset, for example perpendicular, from one another. The encoder wheels are suitably in contact with the ball and configured to rotate in dependence on rotation of the ball.

Suitably the rotational encoder is configured to detect movement in perpendicular directions, e.g. x and y directions. In some examples a single encoder wheel may be provided to detect movement in a single direction. In some examples where two encoder wheels are provided, the encoder wheels need not rotate about respective axes that are perpendicular to one another.

The ball is, in at least some examples, disposed towards a side of the scanning apparatus configured to face towards the object. The ball preferably protrudes from the side of the scanning apparatus configured to face towards the object. In some examples the ball is mounted to a resilient mechanism which is movable relative to the scanning apparatus such that the ball is movable into and out of the scanning apparatus. This arrangement permits the ball to contact the surface of the object, so as to detect movement of the scanning apparatus along that object, whilst at the same time enabling the ultrasound-transmitting surface of the scanning apparatus to be applied to the object with the desired force. In some examples, the provision of the ball does not affect the force with which the scanning apparatus can be applied to the surface of the object.

Each encoder wheel is configured to output a signal that is indicative of a distance that the scanning apparatus is moved along the surface of the object in a direction detected by that encoder wheel. In the example above where one encoder wheel is configured to detect distance along an x direction, and another encoder wheel is configured to detect distance along a y direction, the local positioning system can output one signal indicative of the distance moved in the x direction and another signal indicative of the distance moved in the y direction. Note that the x and y directions as referenced herein need not be oriented in any particular direction relative to a frame of reference such as the object, or an environment of the object. Rather, the x and y direction denote that, in these examples, the directions are perpendicular to one another.

The local positioning system may comprise an optical positioning system. The optical positioning system may be configured to determine a change in position in dependence on the detection of light reflected from a surface of an object as the scanning apparatus is moved across the surface. The optical positioning system may detect specularly reflected light from a surface of an object.

In some examples, the local positioning system comprises an inertial measurement unit. The inertial measurement unit can comprise a gyroscope and/or an accelerometer. The inertial measurement unit may comprise a one-axis accelerometer. The inertial measurement unit may comprise a two-axis accelerometer. The inertial measurement unit may comprise a three-axis accelerometer.

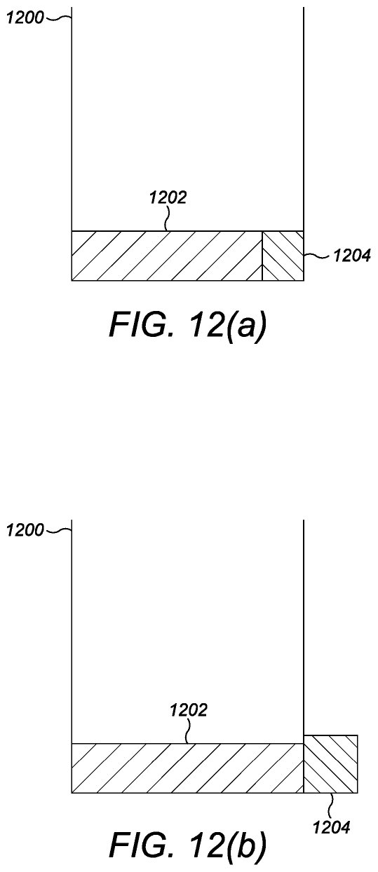

Suitably the local positioning system couples to a general purpose I/O interface of the scanning apparatus. The scanning apparatus may comprise a transducer module which comprises the transducer. The local positioning system may be provided at the transducer module, for example adjacent the transducer. Examples of such arrangements are illustrated in FIGS. 12a and 12b. FIG. 12a shows a transducer module 1200 comprising a transducer 1202 and a local positioning system 1204. The transducer 1202 is located at a surface of the transducer module for facing an object under test. The local positioning system is provided at the same surface of the transducer module, adjacent the transducer. The local positioning system is located within a housing of the transducer module. Locating the local positioning system in this way can help protect the local positioning system.

As discussed elsewhere herein, the local positioning system may comprise a rotational encoder and/or an optical positioning system. Providing the local positioning system at the surface of the transducer module for facing the object under test enables the local positioning system to determine a local position, or a relative local position, as the transducer module is moved across a surface of the object under test.

An alternative configuration is illustrated in FIG. 12b. As with the example illustrated in FIG. 12a, the transducer module 1200 comprises a transducer 1202 and a local positioning system 1204. In this example, however, the local positioning system is coupled to the outside of a housing of the transducer module. This approach can simplify the manufacture of the transducer module. As illustrated, the transducer 1202 can be provided across the whole of an interior of the housing of the transducer module. This can simplify the retention of the transducer within the housing. This approach also facilitates a retro-fitting of the local positioning system to existing transducer modules. There is no need to redesign the transducer module so as to provide the local positioning system within the housing. Rather, the local positioning system may usefully be provided exterior to the housing, as part of the transducer module. Suitably, the local positioning system is provided so as to engage with the surface of the object under test, e.g. in a similar manner to the local positioning system illustrated in FIG. 12a.

The local positioning system can be provided such that the surface of the local positioning system for facing the object is along the same plane as the surface of the transducer for facing the object. Suitably the surface of the local positioning system and the surface of the transducer are continuous with one another, or substantially continuous.

Locating the local positioning system adjacent the transducer can increase the accuracy of the local positioning determination in relation to the part of the object under test. For example, where the object is not a flat object, it can be useful to position the local positioning system adjacent, or relatively near to, the transducer so that the local positioning system can engage with the surface of the object as the surface of the object is scanned by the transducer.

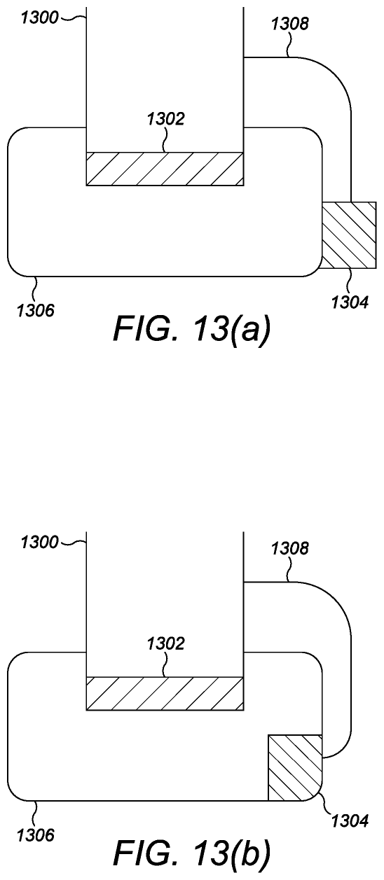

An alternative arrangement will now be described with reference to FIGS. 13a and 13b. In some use cases, the transducer module can be placed directly against the object under test. In such cases, the arrangements of FIGS. 12a and 12b can be used. In other use cases, it may be desirable to provide a coupling, such as a dry coupling, between the transducer and the surface of the object under test. This can be done to improve the transmission of ultrasound into the object and/or to introduce a desired delay in the timing of receiving the reflection at the transducer. The coupling can be provided by way of a coupling shoe, as illustrated in FIGS. 13a and 13b. FIG. 13a shows a transducer module 1300 comprising a transducer 1302. A local positioning system 1304 is provided on or as part of a coupling 1306 such as a coupling shoe. The local positioning system can be connected to the transducer module, for example to a general purpose I/O interface of the transducer module by a wired connection 1308 and/or wirelessly. Where the local positioning system 1304 comprises a wireless connection module, the local positioning system may additionally or alternatively connect directly to a remote system.

The local positioning system may be provided exterior to the coupling (for example mounted to an exterior surface of the coupling) as illustrated in FIG. 13a, or interior to the coupling (for example as part of the coupling or in a recess in the coupling) as illustrated in FIG. 13b.

Suitably the local positioning system 1304 is provided such that a surface of the local positioning system for facing the object under test is along the same plane as the surface of the coupling for facing the object. Suitably the surface of the local positioning system and the surface of the coupling are continuous with one another, or substantially continuous.

It will be understood that arrangements may be provided in which a transducer module having a first local positioning system either within or external to the housing can be provided with a coupling that comprises a second local positioning system. In this case, the first local positioning system can be used where the transducer module is used without a coupling, and the second local positioning system can be used where the transducer module is used with the coupling. This approach provides flexibility in the use of the transducer module and of the local positioning systems.

The examples of the local positioning system described above with reference to FIGS. 12 and 13 are configured to interface with a surface of an object under test so as to determine a local position or relative local movement.

The local positioning system can be configured to determine a local position or relative local movement without needing to interface with a surface of an object under test. For example, the local positioning system can comprise a gyroscope.

In some implementations, the local positioning system can comprise an arrangement configured to determine the local position or relative local movement by interfacing with a surface of an object under test and another arrangement configured to determine the local position or relative local movement without needing to interface with a surface of an object under test. In other implementations, only one of these arrangements need be provided.

Where the local positioning system comprises an arrangement that need not interface with the object directly, such as a gyroscope, the local positioning system need not be located at the scanning surface of the transducer module. In such cases, the local positioning system can be provided at the top of the transducer module, i.e. away from the scanning surface. This location is convenient since, in some implementations of the transducer module, the general purpose I/O port, to which the local positioning system is suitably coupled, can be located at the top of the transducer module. This position of the local positioning system also enables a more compact scanning surface to be provided. Where the local positioning system is spaced from the transducer, the relative positioning of the local positioning system and the transducer can be determined, suitably during manufacture, such that the location of the transducer can be determined by the local positioning system.

In some examples, the location sensor comprises a remote positioning system. The remote positioning system is preferably configured to determine the absolute location data. The remote positioning system may comprise an emitter provided at the scanning apparatus and a plurality of detectors located remotely from the scanning apparatus. In some examples, one or more emitter may be provided remote from the scanning apparatus, and one or more detector may be provided at the scanning apparatus.

The emitter may emit electromagnetic radiation and the detectors may be configured to detect the emitted radiation. In some examples, the emitter is an infrared light and the detectors are image sensors configured to detect infrared light.

In other examples, the emitter can emit radio waves, and the detectors can be radio detectors. The remote positioning system can determine the absolute location data by triangulating the emitted electromagnetic radiation. The remote positioning system can determine the absolute location data using time-of-flight measurements of the emitted electromagnetic radiation.

The scanning apparatus may comprise the emitter.

Preferably, the scanning system, for example the location sensor of the scanning system, is configured to combine data from a plurality of positioning systems. The plurality of positioning systems may comprise at least one local positioning system. The plurality of positioning systems may comprise at least one remote positioning system. Preferably, the plurality of positioning systems comprises at least one local positioning system and at least one remote positioning system.

In some situations, a remote positioning system may not be able to uniquely determine a location on an object at all times. An example of this is where the remote positioning system comprises infrared transmitters and receivers. Where the infrared transmitters are always visible to the infrared receivers, it is possible to determine where the scanning apparatus is located. However, it may be the case that a user operating the scanning apparatus, another object, or a part of the scanning apparatus itself blocks the view between a transmitter and a receiver. When this occurs, the remote positioning system comprising the infrared transmitters and receivers may no longer be able to accurately determine the position of the scanning apparatus.

A further positioning system may be provided that can increase the accuracy of the location of the scanning apparatus in situations like the one described above.

The further positioning system is able to determine a first position in a first frame of reference and a second position in a second frame of reference. The further positioning system can determine a transformation between the second frame of reference and the first frame of reference, thereby to determine the second position in the first frame of reference.

The first frame of reference suitably permits positions to be determined uniquely to the object. For example, the first frame of reference can, for example, relate to the object as a whole, to a uniquely determinable portion of the object, to a workbench on which the object is locatable, or to a room or hangar in which the object is locatable. The second frame of reference may be such as to not permit positions to be determined uniquely to the object. For example the second frame of reference can relate to a portion of the object that might be indistinguishable from another portion of the object.

For instance, the further positioning system can be used at two distances from the object. A first distance is greater than a second distance. At the first distance from the object, the further positioning system has a relatively wider field of view. Thus, this relatively wider field of view can define the first frame of reference. Where the relatively wider field of view encompasses the object as a whole, a position on the object can be uniquely determined. It is noted that the relatively wider field of view need not encompass the entire object for the position to be uniquely determinable.

At the second distance from the object, the further positioning system has a relatively narrower field of view (i.e. narrower than the relatively wider field of view at the first distance). The relatively narrower field of view may define the second frame of reference. Where the relatively narrower field of view does not encompass any unique features of the object, it may not be possible to define a position in the second frame of reference in a way that is unique to the object, since the relative location of the second frame of reference to the object may not be known.

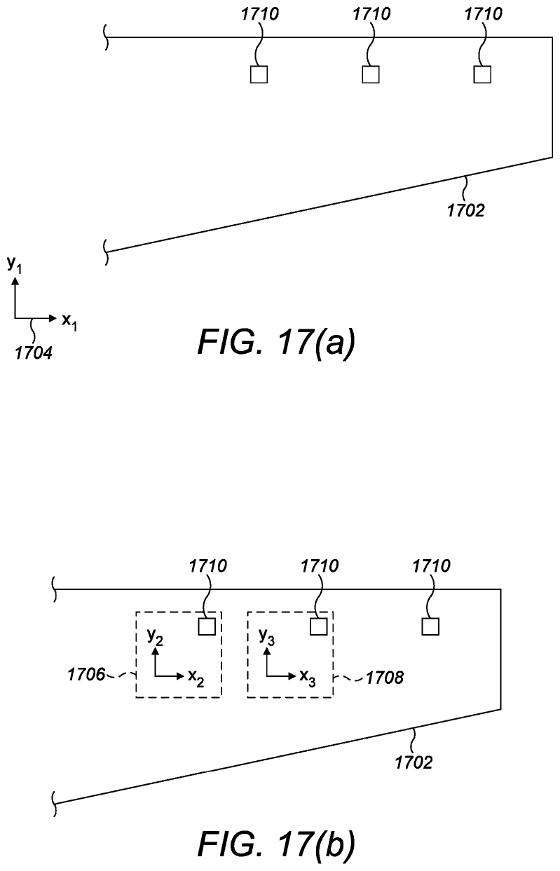

Reference is made to FIGS. 17a and 17b, which illustrate how different fields of view of an object such as an aircraft wing may relate to one another. FIG. 17a shows a representation of a portion of a wing 1702 in a first field of view. The first field of view encompasses a bulk of the wing. The wing can be located in an aircraft hangar. The first frame of reference, indicated at 1704, can be defined by (x₁, y₁). The first frame of reference relates to the hangar. Thus a position in the first frame of reference can uniquely define a location on the wing.

FIG. 17b shows the same portion of the wing 1702 as in FIG. 17a. Two further fields of view are indicated in FIG. 17b. A second field of view is indicated at 1706. A second frame of reference, in the second field of view, can be defined by (x₂, y₂). A third field of view is indicated at 1708. A third frame of reference, in the third field of view, can be defined by (x₃, y₃). Each of the second field of view and the third field of view are narrower than the first field of view. In many situations it may not be possible to determine a spatial relationship between a point (xᵢ, yᵢ) in the second frame of reference and that point (or another point) in another frame of reference, for example either the first frame of reference or the third frame of reference. The location of the point (xᵢ, yᵢ) in the second frame of reference may therefore not be able to be uniquely determined relative to the wing 1702.

At a relatively greater distance, a relatively wider field of view (e.g. the first field of view) can enable a point on an object to be uniquely determined. At a relatively smaller distance, a relatively narrower field of view (e.g. the second field of view or the third field of view) may not enable a point on the object to be uniquely determined. It is therefore useful to consider how to transform a position in one frame of reference to another frame of reference.

One or more markers 1710 may be provided which can provide a link between the first frame of reference and the second frame of reference. The one or more markers can be mounted on the object, positionally fast with respect to the object or otherwise engaged with the object. For example, the one or more markers can be attached to an object adhesively, magnetically, via suction cup, and so on. Generally the one or more markers can be attached to the object or in registration with the object in any suitable manner. For instance, a marker can be retained on an object under the influence of gravity. Whilst retaining a marker on an object using gravity alone is likely to be sufficient in some cases, it is generally desirable to attach markers in a more secure manner, for example so as to be able to attach markers securely to inclined surfaces.

Suitably the markers are attached to or retained on the object in a way which does not affect the structure of the object. Thus, damage to the object can be avoided.

Suitably each of a plurality of markers are distinguishable from one another. Suitably the or each marker is configured so that a rotation of the marker can be determined, e.g. the or each marker can comprise a rotationally asymmetrical feature.

The way in which the markers can provide the link between the first frame of reference and the second frame of reference will now be explained. One or more markers can be applied to the object, and the further positioning system used at the first distance to determine the locations on the object of each of the markers in the first frame of reference. Thus, the position of each marker can be uniquely determined on the object.

The further positioning system can be used at the second distance, e.g. by obtaining a representation of the object at the narrower field of view, to determine a location on the object in the second frame of reference relative to one or more of the markers. Based on knowledge of the position in the first frame of reference of those one or more markers, the determined location in the second frame of reference can then be transformed into a position in the first frame of reference, and the location on the object uniquely determined.

Where each marker is distinct, it is only necessary for the representation of the object at the narrower second field of view to encompass a single marker. Where the orientation of the marker is able to be determined uniquely, i.e. where the marker does not have rotational symmetry, the presence of that marker is sufficient to be able to uniquely determine a location on the object as a whole, i.e. in the first frame of reference. Where the marker has rotational symmetry it may be necessary for the representation of the object at the narrower second field of view to encompass two or more markers, or at least one marker and another distinguishing feature, such as an edge of the object. In this case, the orientation of the second frame of reference relative to the first frame of reference can be uniquely determined. Thus, in this case, the markers need not be distinct from each other marker.

The further positioning system may comprise an image capture device for capturing images of the object and/or the one or more markers. Suitably the markers are visually distinguishable from one another. The (relatively wider) first field of view of the image capture device at the first distance may define the first frame of reference. The (relatively narrower) second field of view of the image capture device at the second distance may define the second frame of reference. The image capture device may comprise a camera. The image capture device may comprise a CCD.

Thus, the image capture device of the further positioning system can be used to capture an image of a plurality of markers when at a first distance from the object, such as a wing of an aeroplane. On approaching the wing, the field of view of the image capture device may only encompass a single marker. Despite this, a location in an image captured by the image capture device can still be uniquely determined with respect to the object (e.g. the wing) as a whole.

The location sensor may be configured to combine the data from the plurality of positioning systems in dependence on a measure of accuracy of each positioning system.

For example, the data can be combined in a way that emphasises more accurate data. In some examples, a weighted combination of data can be performed. The weighting applied to data from each positioning system can be based on the measure of accuracy of that positioning system.

The measure of accuracy can comprise an estimation of the accuracy of the positioning system. The measure of accuracy can comprise a calibrated accuracy of the positioning system. The measure of accuracy can comprise an average accuracy of the positioning system.

In some examples, the weighting can be user-selected. This approach enables a user to configure the system as desired, for example to obtain a desired balance between the different sets of location data.

Suitably the data from the positioning systems is filtered. The filtering preferably occurs before the data is combined. The filtering can comprise statistical filtering methods. The filtering can comprise applying a Kalman filter. The filter may be a weighted filter. The weighting applied by the weighted filter can be based on the measure of accuracy of the respective positioning system from which that data was obtained.

The configuration unit may be arranged to select configuration data for configuring the scanning apparatus, and to send the selected configuration data to the scanning apparatus so as to configure the scanning apparatus.

The sensed location can indicate an object, or part of an object, adjacent which the scanning apparatus is located. For example, the sensed location can indicate whether the scanning apparatus is adjacent a metal plate or adjacent a laminated polymer. The scanning system is suitably configured to determine this information relating to an object from a knowledge of the location of one or more object. Such information relating to an object can be stored in a database accessible to the scanning system. The scanning system may comprise at least a part of the database. Suitably at least a part of the database can be provided remotely, for example in the cloud.

In some examples, the configuration data comprises data for selecting a pulse template from a plurality of pulse templates. The scanning apparatus may have access to a plurality of pulse templates. The plurality of pulse templates comprises pulses of different timings and/or shapes. Each of the pulse templates may have differing characteristics to at least one other pulse template. Thus, for a given material and/or expected feature in an object under test, a given pulse template may be expected to yield more information, or more accurate information, than another pulse template.

In some examples, the scanning apparatus may have access to a pulse selection module configured to select a pulse from the plurality of pulse templates for generation and transmission as an ultrasound pulse into the object. The configuration data can be configured to control the pulse selection module to select a pulse template appropriate to the object or to the part of the object located adjacent the location of the scanning apparatus.

The pulse template can be selected in dependence on the material of the object adjacent the sensed location and/or the features expected in the object adjacent the sensed location.

The configuration data may comprise data relating to a physical reconfiguration of the scanning system, and the instructions to the user may comprise an instruction to change the physical configuration of the scanning system. The scanning system may be configured to indicate the physical reconfiguration of the system on the indicator.

The physical configuration of the scanning system can comprise the presence and/or type of coupling provided at the scanning apparatus for coupling emitted ultrasound signals into the object and for coupling reflected ultrasound signals into the scanning apparatus. The physical reconfiguration of the coupling can comprise changing the coupling from a straight to an angled coupling or from an angled coupling to a straight coupling. In one example, where a scanning apparatus is brought close to a weld extending beneath the surface of an object, and it is desired to scan the weld, the sensed location can indicate that the scanning apparatus is adjacent the weld, and the instruction unit can instruct the user to change a flat coupling for an angled coupling, so that the side of the weld can be appropriately imaged.

The sensed location can indicate a material of a known type against which the scanning apparatus is placed. In some examples, different couplings may be appropriate for different material types, for example the thickness and/or material of the coupling can be selected to optimise the coupling efficiency of ultrasound signals into and out of that material. In some examples, the configuration data can comprise data relating to the particular coupling that is suitable or most appropriate for the material at the sensed location. Where the desired coupling is not the coupling that is provided at the scanning apparatus at that time, the instructions to the user can instruct the user to change the coupling to the desired coupling. This approach can ensure that the scanning apparatus is optimised for scanning the object under test at the sensed location.

Different couplings that might be attached to the transducer can differ in one or more of size, frequency transmission, impedance, hardness and/or thickness. A sealing element can be provided at or towards an edge of the transducer. The sealing element may be provided around the perimeter of the transducer. The sealing element may be a resilient seal, such as a rubber seal. The provision of the seal allows couplings to be quickly and easily replaced, whilst keeping the transducer module watertight.

The present techniques may relate to a scanning system for imaging an object, in which the scanning system comprises a scanning apparatus configured to transmit ultrasound signals towards an object and to receive ultrasound signals reflected from an object whereby data pertaining to an internal structure of an object can be obtained. The scanning system may further comprise a location sensor for sensing a location of the scanning apparatus. The scanning system can also comprise an image generation unit configured to generate an image representative of an object in dependence on the data pertaining to an internal structure of an object (e.g. the obtained data) and the sensed location of the scanning apparatus at which that data was obtained.

Knowledge of the location of the scanning apparatus as data from each scan is obtained enables the image generation unit to determine how the data obtained from one scan relates to data obtained from another scan. For example, where the scans are from adjacent locations on a given surface of the object, the image generation unit can determine this, and can generate a composite image in dependence on data from both scans accordingly. For example, where the first scan is performed with the scanning apparatus to the left, say, of a given location on the object surface, and the second scan is performed with the scanning apparatus to the right, say, of the same given location on the object surface, then the composite image can be generated by aligning images generated from each separate scan.

In another example, the areas on the object surface over which the scan is performed might overlap, or might be spaced from one another. Knowledge of the location of the scanning apparatus as the scans are performed enables the resulting images to be combined appropriately. In the former case the images can be stitched together at the appropriate part of the images. In the latter case, the images can be appropriately spaced from one another when, for example, displayed on a model of the object.

Patterns can be identified in the data, from one frame (or scan) to another and/or from one pixel of a scan to another. The identified patterns can be used to stitch images together. The data may be bitmap data, and standard pattern recognition techniques can be used to identify patterns in the data. Images can be stitched together using image processing algorithms. The identified patterns may be complex. For example, the data can comprise one or, or some combination of, an A-scan, a B-scan and a C-scan. Thus, depth can be taken into account when identifying patterns and performing image stitching. Taking depth into account can assist in tracking positions from one frame to another, i.e. from one image to another.

Combining, or stitching, the images (or more generally, the captured data) in this way enables a composite image to be built up. The composite image can be generated with respect to a location (or more than one separate location) on the object. For instance, data can be shown on a model of the object, such as a CAD model of the object. On moving the scanning apparatus across the object, or on scanning different parts of the object, this data can be shown on the relevant portion of the model. Thus, moving the scanning apparatus across the surface of the object can lead to the model of the object being ‘painted’ with the data. This can provide a visual indication to a user of the system of the results of the scan in real-time. Usefully, this approach can also indicate to the user where the signal to noise ratio is below a desired or pre-set threshold, enabling the user to rescan the object in order to obtain a more accurate image.

A ‘front wall’ detection system may be employed. Such a front wall detection system can be configured to monitor the penetration echo of ultrasound into the front surface of the material under test. Ideally, the penetration echo is kept as small as possible, so that as much as possible of the ultrasound energy passes into the material under test. Where the penetration echo is high, this can indicate that the coupling between the transducer and the object under test is poor. Thus, the front wall detection system can be configured to determine whether the penetration echo exceeds a threshold value (which may, for example, be an absolute amplitude value, or a ratio of the transmitted energy), and in response to the penetration echo exceeding the threshold value can determine that the coupling between the transducer and the object is insufficient to achieve good scan results. The system can then prompt the user to re-scan the object and/or take steps to improve the coupling.

Such approaches can enable a user to appreciate in real-time where any gaps in scan coverage and/or poor scan results might appear, enabling the user to scan the object at those locations in order to remove the gaps and/or improve the scan results and obtain data from all relevant portions of the object. Providing this functionality in real-time can mean that a scan need not be later set up again to obtain the missing data. Rather, the scan can more efficiently be carried out in a single process.

The ‘painted’ model may be displayed on a display, for example a display held by a user of the scanning apparatus. For example, the scanning apparatus may be coupled to a tablet computer that comprises a display, and the real-time results of the scan shown on that display. The ‘painted’ model may be displayed to a user by way of an augmented reality display, or virtual reality display, for example in a pair of glasses worn by the user. This can enable the captured data to be overlaid on the object itself, and provides a clearer indication to the user of the scan locations.

The scans might be performed with the scanning apparatus at differing orientations. Knowledge of the location of the scanning apparatus, which location comprises orientation information, permits the image generation unit to correctly orient the images generated from each separate scan when combining the images together.

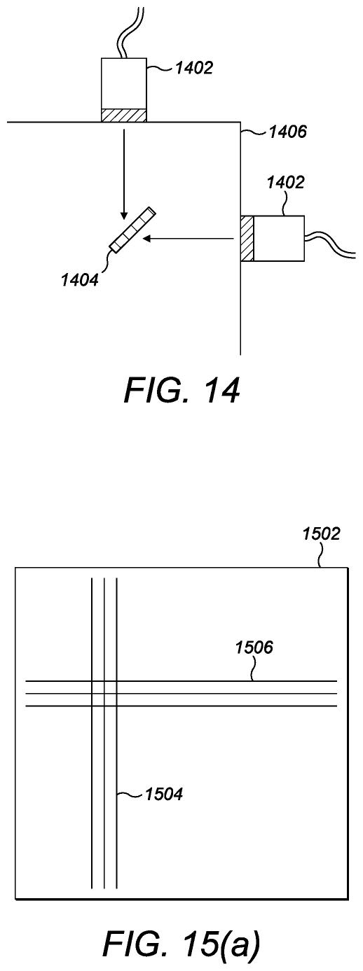

Reference is made to FIG. 14, which shows two transducer modules 1402 (or a single transducer module being used in two locations) imaging a subsurface feature 1404 in an object 1406. Both images will comprise information regarding the subsurface feature. Due to the different imaging directions, the information regarding the subsurface feature is likely to differ between the images. Knowledge of the relative orientations and positions of the transducer modules when capturing the images enables a more accurate registration between the captured images, which can lead to a more accurate 3D representation of the subsurface feature being generated, facilitating more accurate analysis of that representation.

In some examples, the image generation unit is configured to detect a feature in first scan data obtained at a first sensed location; detect a feature in second scan data obtained at a second sensed location; determine, based on the first and second sensed locations that the detected feature in each of the first scan data and the second scan data is the same feature; and combine the first scan data and the second scan data in dependence on the determination.

The image generation unit may be configured to determine an orientation of the detected feature in the first scan data and an orientation of the detected feature in the second scan data. The image generation unit is suitably configured to combine the first scan data and the second scan data in dependence on the determined orientations, for example in dependence on a difference between the determined orientations. For example, one or other of the first scan data and the second scan data can be rotated by the determined difference between the determined orientations. Suitably the first scan data and the second scan data are rotated relative to one another by the determined difference between the determined orientations. The first scan data and the second scan data can subsequently be combined.

For example, the image generation unit can be configured to derive an image from the first scan data. The image may show a feature such as a defect, a material transition in the object or a rivet. The image generation unit can be configured to derive another image from the second scan data. This image may also show a feature. Where it is determined, for example by the image generation unit, based on the sensed scanning location of the scanning apparatus for each scan, that the identified features in the images correspond to one another, e.g. that they are the same feature, the image generation unit is suitably configured to combine the images based on this determination. This can be used as an additional check that the images are being stitched together correctly, and can increase the accuracy of the image combination, and/or the confidence with which the images can be stitched together.

To take an example, say the location can be sensed to within 0.5 mm. Where the features in the images can be detected to within 0.1 mm, basing the image registration on the detected features is likely to lead to an increased accuracy of image registration. These figures are merely examples to illustrate the potential increase in accuracy. The benefit of this approach can be obtained where other location errors are present. It will be appreciated that the registration of images based on features detected in those images can lead to an increase in the accuracy of image registration where the feature detection location error is less than the location sensing error.

In some examples, an increase in accuracy may be obtained even where the feature detection location error is the same as or greater than the location sensing error. For example, there may be an offset error in the sensed location, and/or a drift in the error over time. The feature detection may be able to provide a more accurate location based on a knowledge of the feature of the object. For example, where it is known that a material transition occurs at, say, x=4 [units], and the sensed location corresponding to the material transition is x=(4.3±1) [units], it can be determined that an additional error is present, such as an offset error. If this error changes over time it can be determined to be a drift error. The detected location of the feature, here the material transition, can therefore be used to increase the overall accuracy of the image location and/or registration.

Suitably the transducer comprises a matrix array of transducer elements. The transducer may comprise a 128×128 array of 16384 transducer elements. Each of these transducer elements may be used to generate a pixel of data. Using these transducer elements separately enables pixel-level accuracy to be obtained in the determination of location. The transducer may be 32 mm×32 mm. Thus, a pixel may cover approximately 0.25 mm×0.25 mm. The transducer elements need not be used separately. A group of the transducer elements can be used together. Usefully, this can increase the signal to noise ratio.

Typically the scanning apparatus will emit a series of pulses as it is moved across an object, and will detect reflections of those pulses to obtain information about the subsurface structure of the object. The emitted pulses need not all be the same type of pulses, and need not be emitted by the same transducer elements or groups of transducer elements. Advantageously, additional data can be obtained relating to the object by varying the nature of the transmitted pulses.

A typical scanning apparatus may be configured to scan at approximately 10 to 100 frames per second. That is, the scanning apparatus can transmit 10 to 100 ultrasound ‘shots’ per second. Preferably the scanning apparatus will be configured to scan at approximately 80 to 100 frames per second. A subset of these ‘shots’ can be used to perform different scans, thereby obtaining additional data in a single pass.

For example, every nth shot can be a tracking shot. The tracking shot can be a pulse with a greater energy thereby providing a more accurate depth scan, for example for determining the thickness of a test object, or of a back wall of a test object. For instance, where the test object is a pipe, the thickness of a wall of the pipe can be determined. n may be in the range of 5 to 10, thus every 5th to 10th pulse can be a tracking pulse.

The scanning apparatus may be configured so that a tracking shot is emitted every 2 to 3 mm along a direction of motion of the scanning apparatus.

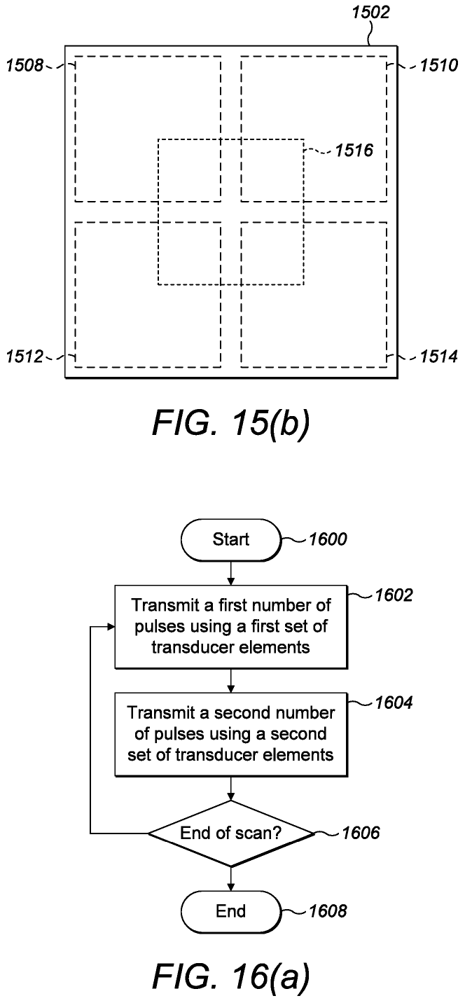

FIG. 15 illustrates how the scan types can be varied. FIG. 15a illustrates a transducer matrix 1502 comprising orthogonal conducting lines 1504 1506 (only a subset is shown for clarity), the intersections of which define transducer elements. The transmission of ultrasound can be caused by driving single transducer elements, or lines of transducer elements. FIG. 15b shows an alternative, in which transducer elements of the matrix 1502 can be grouped into a plurality of groups. As illustrated the transducer elements are grouped into a first group 1508, a second group 1510, a third group 1512, a fourth group 1514 and a fifth group 1516. The first to the fourth groups are non-overlapping and generally each define a quarter of the matrix 1502. The fifth group overlaps with a portion of each of the first to fourth groups. Groups of other shapes and sizes may be defined as desired. Other numbers of groups may be defined as desired.

It is not necessary in all examples for the groups to cover the whole of the matrix array of transducer elements. The groups may, together, cover a subset of the transducer array.

In the tracking shot, a group of transducer elements can be fired at once, for example all of the elements in one or more of the first to fifth groups. Firing a greater number of transducer elements at once will increase the energy of the resulting ultrasound pulse, thereby enabling a more accurate depth to be obtained from that pulse compared to a pulse emitted using fewer transducer elements.

Interspersing standard scans with tracking scans enables an accurate depth to be obtained as well as detail relating to the scan volume, in a single pass. More generally, the scanning apparatus can be used to intersperse a plurality of scans of a first scan type with at least one scan of a second scan type. The scanning apparatus can be used to intersperse the plurality of scans of the first scan type with at least one scan of a third scan type. Suitably scans of the second scan type and optionally scans of the third scan type are regularly interspersed with scans of the first scan type.

In some cases the group of transducer elements fired at the same time for a tracking shot can be of an arbitrary shape, for example a user-defined shape. The group of transducer elements fired at the same time for the tracking shot can be of a shape corresponding to the shape of a feature identified in a previous scan. The previous scan may be an immediately preceding scan, but it need not be. In this way, the depth of that feature, or an average depth of that feature, can be more accurately determined.

The use of tracking shots in this way can enable more accurate depths to be obtained at regularly spaced intervals. This can assist with combining images generated using the scanning apparatus. For example, small variations in a feature of an object, such as a back wall or a wall thickness, can be accurately determined by the tracking scan, and can be used to determine more accurately how the position of the scanning apparatus has changed between scans thereby enabling a more accurate composite image to be formed from images captured in separate scans.

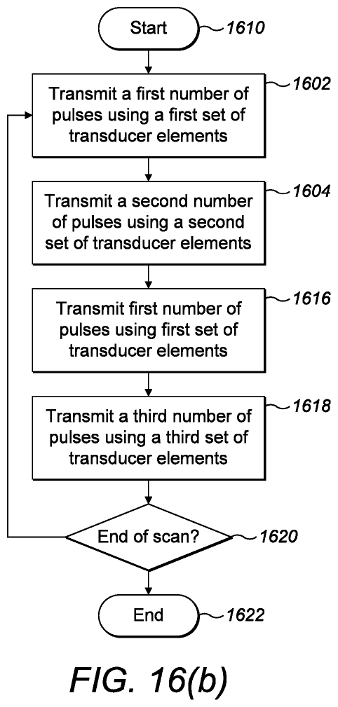

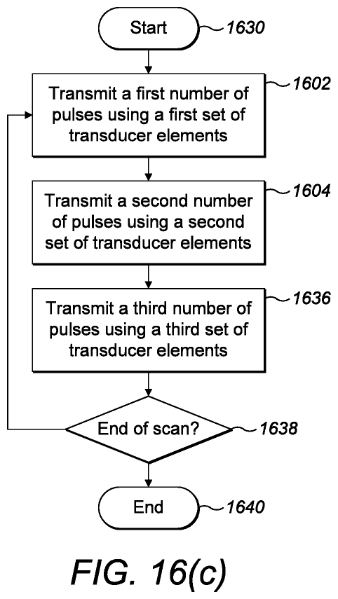

A method of scanning an object with interspersed scanning modes will now be described with reference to FIGS. 16a to 16c. Referring first to FIG. 16a, the method starts at 1600. The method comprises transmitting a first number of pulses using a first set of transducer elements 1602. Reflections of the transmitted first number of pulses are received. The first set of transducer elements are at least part of a matrix transducer array. The first set of transducer elements may comprise a single transducer element. The first set of transducer elements may comprise a plurality of transducer elements. The first number of pulses are pulses of a first scan type, for example a volume scan. The first number of pulses is suitably a plurality of pulses.

The method comprises transmitting a second number of pulses using a second set of transducer elements 1604. Reflections of the transmitted second number of pulses are received. The second set of transducer elements are at least part of a matrix transducer array. The second set of transducer elements suitably comprises a plurality of transducer elements. The second set of transducer elements suitably differs from the first set of transducer elements. For example, the second set of transducer elements can comprise more transducer elements than the first set of transducer elements. The second set of transducer elements may at least partially overlap with the first set of transducer elements. For example, the second set of transducer elements may comprise the transducer elements of the first set of transducer elements, together with additional transducer elements of the transducer matrix array. The second number of pulses are pulses of a second scan type, different to the first scan type. The second scan type may be, for example, a depth scan. The second number of pulses may comprise a single pulse. The second number of pulses may comprise a plurality of pulses. The second number of pulses may be less than the first number of pulses.

The first number of pulses and/or the second number of pulses may, for example, be selected in dependence on one or more of an object under test, a material of the object under test, a thickness of the object under test, a feature of the object under test, a speed of movement of the scanning apparatus, a size of a transducer array, a shape of the transducer array and a transducer element size.

The method can then determine whether the scan is completed 1606 and if so can terminate 1608, otherwise the method can comprise looping back to transmitting the first number of pulses using the first set of transducer elements 1602.

In an example, the first number of pulses is 9 and the second number of pulses is 1. Thus, the second type of scan will be interspersed with the first type of scan every 10th shot.

In an alternative, rather than the second type of scan repeating after a certain number of pulses of the first type of scan, the second type of scan can be performed after a certain distance of movement of a scanning apparatus. For example, the scanning apparatus can be configured to transmit pulses of a first type of scan until a multiple of a threshold distance has been moved, then to transmit a predefined number of pulses of a second type of scan (or to transmit pulses of the second type of scan until a certain distance has been moved by the scanning apparatus) before returning to transmitting pulses of the first type of scan until the next multiple of the threshold distance has been moved. The threshold distance can be 2 to 3 mm. Any other threshold distance can be selected as desired. The threshold distance may, for example, be selected in dependence on one or more of an object under test, a material of the object under test, a thickness of the object under test, a feature of the object under test, a speed of movement of the scanning apparatus, a size of a transducer array, a shape of the transducer array and a transducer element size.

As illustrated in FIG. 16a, two different scanning modes can be interspersed. In other example a greater number of scanning modes can be interspersed with one another. Examples of interspersing three scanning modes are illustrated in FIGS. 16b and 16c. It will be apparent to the skilled person that these techniques can be expanded to any desired number of scanning modes.

Referring to FIG. 16b, the method of scanning an object with interspersed scanning modes starts at 1610. As with the example of FIG. 16a, the method comprises transmitting the first number of pulses using the first set of transducer elements 1602. Reflections of the transmitted first number of pulses are received.

The method comprises transmitting the second number of pulses using the second set of transducer elements 1604. Reflections of the transmitted second number of pulses are received.

The method comprises transmitting the first number of pulses using the first set of transducer elements again 1616. Reflections of the transmitted first number of pulses are received.

The method comprises transmitting a third number of pulses using a third set of transducer elements 1618. Reflections of the transmitted third number of pulses are received. The third set of transducer elements are at least part of a matrix transducer array. The third set of transducer elements suitably comprises a plurality of transducer elements. The third set of transducer elements suitably differs from the first set of transducer elements and/or from the second set of transducer elements. For example, the third set of transducer elements can comprise a different number of transducer elements compared to the first and/or second sets of transducer elements. The third set of transducer elements can comprise transducer elements forming a different shape from transducer elements of the first and/or second sets of transducer elements. For example, the third set of transducer elements can comprise transducer elements shaped to correspond to a shape of a feature of interest projected onto the plane of the matrix array. The third set of transducer elements may at least partially overlap with the first and/or second sets of transducer elements. The third number of pulses are pulses of a third scan type, different to the first and second scan types. The third scan type may be, for example, a scan related to a particular subsurface feature of interest. The third number of pulses may comprise a single pulse. The third number of pulses may comprise a plurality of pulses. The third number of pulses may be less than the first number of pulses.

The first number of pulses and/or the second number of pulses and/or the third number of pulses may, for example, be selected in dependence on one or more of an object under test, a material of the object under test, a thickness of the object under test, a feature of the object under test, a speed of movement of the scanning apparatus, a size of a transducer array, a shape of the transducer array and a transducer element size.

The method can determine whether the scan is completed at 1620 and if so can terminate 1622, otherwise the method can comprise looping back to transmitting the first number of pulses using the first set of transducer elements 1602.

In an example, the first number of pulses is 8, the second number of pulses is 1 and the third number of pulses is 1. Thus, the second and third types of scan will be interspersed with the first type of scan every 10th shot. The second number of pulses may be greater or smaller than the third number of pulses. Thus, the second type of scan can occur for a greater or smaller duration than the third type of scan.

In the example illustrated in FIG. 16b, the first type of scan occurs between the second and third types of scan. This need not be the case. Referring to FIG. 16c, the first type of scan (at 1602), the second type of scan (at 1604) and the third type of scan (at 1636) can be performed in order.

In alternatives, rather than the second and/or third types of scan repeating after a certain number of pulses of other types of scan, the second and/or third types of scan can be interspersed with the other types of scan after a certain distance of movement of a scanning apparatus. For example, the scanning apparatus can be configured to transmit pulses of the first type of scan until a multiple of a threshold distance has been moved, then to transmit a predefined number of pulses of the second type of scan (or to transmit pulses of the second type of scan until a certain distance has been moved by the scanning apparatus) before returning to transmitting pulses of the first type of scan until the next multiple of the threshold distance has been moved. At this point, the scanning apparatus can be configured to transmit a predefined number of pulses of the third type of scan (or to transmit pulses of the third type of scan until a certain distance has been moved by the scanning apparatus). The threshold distance can be 2 to 3 mm. Any other threshold distance can be selected as desired. The threshold distance may, for example, be selected in dependence on one or more of an object under test, a material of the object under test, a thickness of the object under test, a feature of the object under test, a speed of movement of the scanning apparatus, a size of a transducer array, a shape of the transducer array and a transducer element size. The threshold distance which initiates the change from transmitting pulses of the first type to pulses of the second type may be the same as or different to a threshold distance which initiates the change from transmitting pulses of the first type to pulses of the third type or to a threshold distance which initiates the change from transmitting pulses of the second type to pulses of the third type.

In some examples, a scanning system for imaging an object can comprise a scanning apparatus configured to transmit ultrasound signals towards an object and to receive ultrasound signals reflected from an object whereby data pertaining to an internal structure of an object can be obtained. The scanning system can further comprise a location sensor for sensing a location of the scanning apparatus. The scanning system can also comprise a processor configured to determine an estimate of the location of the scanning apparatus in dependence on the sensed location and the data pertaining to an internal structure of an object (e.g. the obtained data).

Referring to FIG. 10, a method may comprise scanning an object 1001. A feature of an object can be identified in the results of the scan 1002. A determination can be made of the location of a scanning apparatus that performed the scan 1003. Where the sensed location is different from a location determined in dependence on the identified feature, an estimate of the location can be determined in dependence on the location of the identified feature 1004.

The scanning system may be configured to output an image generated by the image generation unit for display. The output image can comprise the composite image.

The scanning system may be configured to display the output image on a view of the object. The view of the object is, in some examples, a view of the object obtained from a camera. The view of the object obtained from the camera may comprise a live feed. The view of the object need not be from the same direction as the scanning direction. Suitably the scanning system is configured to compensate for differences in viewing orientation and to appropriately apply the output image to the view of the object. Suitably the scanning system is configured to apply one or more transformation to the output image.

The view of the object may be displayed on a display, such as a display of a tablet computer. Where the view of the object comprises a live feed, the view may change as the camera position changes. Suitably the scanning system is configured to determine the relative changes in location between the scanning apparatus capturing the scan data and the camera capturing the view of the object and to apply the output image to the view of the object accordingly. In some examples, the camera is associated with a positioning system such as an inertial positioning system, and the location of the camera as it moves can be determined in dependence on an output from the associated positioning system.

The view of the object may comprise one of a virtual reality view and an augmented reality view.

The output image can be displayed in a virtual reality view of the object. This enables the output image to be applied to an earlier-captured view of the object, a computer-generated view of the object, or some combination of these two views of the object. In other examples the output image can be displayed as part of an augmented reality (AR) view. For example, the output image can be displayed on AR glasses which enable a user of the AR glasses to view the object in real-time, with the output image applied to the display of the glasses so that a user views the output image as being superimposed over the real-time view of the object. This approach enables a person, who need not be the user of the scanning apparatus, to view the object, such as by walking around the object, so as to inspect the interior of the object as imaged by the scanning apparatus.

In some examples, a scanning system for imaging an object can comprise a scanning apparatus configured to transmit ultrasound signals towards an object and to receive ultrasound signals reflected from an object whereby data pertaining to an internal structure of an object can be obtained. The scanning apparatus may have a non-planar configuration. The scanning system may further comprise a sensor for sensing the non-planar configuration of the scanning apparatus. The scanning system may comprise a configuration unit arranged to configure the scanning apparatus in dependence on the sensed non-planar configuration.

Where the scanning apparatus has a non-planar configuration, it may be appropriate to select the configuration, for example a pulse template for generation by the scanning apparatus, in dependence on the non-planar configuration. For example, where the scanning apparatus adopts a concave transmitting surface, the optimal pulse template is likely to differ from where the scanning apparatus adopts a convex transmitting surface. Similarly, where the scanning apparatus adopts a non-planar surface comprising one or more planar surface, the optimal pulse template is likely to differ once again. Similarly, the timings at which each of a series of transducer elements are fired are likely to differ in dependence on the non-planar configuration.

The differences in optimal pulse templates are likely to be due, at least in part, to the different focussing appropriate to each of the respective non-planar configurations.

Where the scanning apparatus is flexible, for example where the scanning apparatus comprises a flexible support to which a flexible transmitter and a flexible receiver are coupled, the sensor may be configured to sense changes in the non-planar configuration adopted by the scanning apparatus. The configuration unit is, in some examples, configured to re-configure the scanning apparatus in dependence on the sensed changes in the non-planar configuration. This approach helps to ensure that as the transmitting surface of the scanning apparatus changes, the configuration of the scanning apparatus is modified accordingly, thereby permitting optimisation of the scanning process.

In some examples, the sensor may comprise one or more of a strain gauge and an encoder wheel. The strain gauge can sense deformation from which the shape of the non-planar configuration of the scanning apparatus can be determined. The strain gauge may be configured to sense deformation from a planar configuration or from a known non-planar configuration.

The encoder wheel may be provided at or adjacent a joint coupling parts of the scanning apparatus together, for example a hinge between different transducer sections. The encoder wheel may comprise one or more of an optical encoder and a magnetic encoder. The encoder wheel may be configured to generate data indicative of an angle through which parts of the scanning apparatus are rotated relative to one another. Where the encoder wheel provides relative data (e.g. data pertaining to an amount by which the parts are rotated relative to one another), knowledge of an initial state of the scanning apparatus (e.g. before the relative rotation) enables a determination of the non-planar configuration. In some examples, the encoder is configured to generate absolute data relating to the relative positions of the parts of the scanning apparatus, for example an angle between different parts of the scanning apparatus.

In some examples, the scanning system further comprises a location sensor for sensing a location of the scanning apparatus, and the configuration unit may be arranged to configure the scanning apparatus in dependence on the sensed location.

The location sensor can enable a determination to be made of which object, or which part of an object, the scanning apparatus is adjacent. Where the scanning apparatus is adjacent a concave surface of the object, and the scanning apparatus has a fixed convex surface that matches the concave surface of the object, the scanning system can determine that the scanning apparatus will closely fit against the object and can select the configuration of the scanning apparatus accordingly.

In other examples, where the scanning apparatus is adjacent a concave surface of the object, and the scanning apparatus has a fixed convex surface that does not precisely match the concave surface of the object, the scanning system can determine that the scanning apparatus will not fit as closely against the object as in the previous example. Accordingly, it may be anticipated that there will be potentially worse ultrasound coupling between the scanning apparatus and the object in this example. Thus it may be desirable to select a pulse template for use by the scanning apparatus that takes account of this coupling. For example, a pulse template with a higher power output might be selected in this example, which might yield acceptable results despite energy losses due to the poor coupling.

In other examples, the non-planar configuration of the scanning apparatus may be changeable. The sensed location enables a determination to be made of the surface profile of the object adjacent the location of the scanning apparatus. For example, where the scanning apparatus is brought towards an external corner of the object, the configuration unit can be configured to select configuration data for the scanning apparatus that is most appropriate for the shape of that external corner. In examples where the user of the scanning apparatus needs to physically reconfigure the scanning apparatus, for example by modifying the non-planar configuration of the scanning apparatus, the scanning system can prompt the user to perform this reconfiguration based on the shape of the object towards which the scanning apparatus is moved. This approach can help ensure that the scanning apparatus is appropriately configured when applied to the surface of the object, which can lead to the generation of more accurate data and/or more efficient capture of data.

Referring to FIG. 11, a method may comprise sensing a non-planar configuration of a scanning apparatus 1101. The method may further comprise configuring the scanning apparatus in dependence on the sensed non-planar configuration 1102.

The apparatus and methods described herein are particularly suitable for detecting debonding and delamination in composite materials such as carbon-fibre-reinforced polymer (CFRP). This is important for aircraft maintenance. It can also be used detect flaking around rivet holes, which can act as a stress concentrator. The apparatus is particularly suitable for applications where it is desired to image a small area of a much larger component. The apparatus is lightweight, portable and easy to use. It can readily be carried by hand by an operator to be placed where required on the object.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
an instruction unit arranged to provide instructions to a user of the scanning system in dependence on the sensed location.

2. A scanning system according to claim 1, in which the instructions to the user comprise an instruction to one or more of:
re-orient the scanning apparatus at the sensed location;
perform a further scan at the sensed location; and
move the scanning apparatus to a new location.

3. A scanning system according to claim 2, in which the instruction to perform a further scan at the sensed location is provided to the user in dependence on a measure of quality associated with one or more previous scan.

4. A scanning system according to claim 3, in which the measure of quality comprises a measure of the signal to noise ratio of data obtained during the one or more previous scan.

5. A scanning system according to claim 1, in which the scanning system comprises an indicator for indicating to the user a direction in which to move the scanning apparatus.

6. A scanning system according to claim 1, in which the instructions to the user comprise an instruction to move the scanning apparatus so as to image an internal volume of an object from a different location.

7. A scanning system according to claim 1, in which the location sensor comprises one or more of a local positioning system and a remote positioning system, and/or is configured to combine data from a plurality of positioning systems.

8. A scanning system according to claim 7, in which
the local positioning system comprises one or more of a rotational encoder and an inertial measurement unit, and/or the remote positioning system comprises an emitter provided at the scanning apparatus and a plurality of detectors located remotely from the scanning apparatus.

9. (canceled)

10. A scanning system according to claim 9, in which the emitter emits electromagnetic radiation and the detectors are configured to detect the emitted radiation.

11. (canceled)

12. A scanning system according to claim 7, in which the location sensor is configured to combine the data from the plurality of positioning systems in dependence on a measure of accuracy of each positioning system.

13. A scanning system according to claim 1, further comprising a configuration unit arranged to configure the scanning apparatus in dependence on the sensed location.

14. A scanning system according to claim 13, in which the configuration unit is arranged to select configuration data for configuring the scanning apparatus, and to send the selected configuration data to the scanning apparatus so as to configure the scanning apparatus.

15. A scanning system according to claim 14, in which the configuration data comprises data relating to a physical reconfiguration of the scanning system, and the instructions to the user comprise an instruction to change the physical configuration of the scanning system.

16. A scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
an image generation unit configured to generate an image representative of an object in dependence on the obtained data and the sensed location of the scanning apparatus at which that data was obtained.

17. A scanning system according to claim 16, in which the image generation unit is configured to:
detect a feature in first scan data obtained at a first sensed location;
detect a feature in second scan data obtained at a second sensed location;
determine, based on the first and second sensed locations that the detected feature in each of the first scan data and the second scan data is the same feature; and
combine the first scan data and the second scan data in dependence on the determination.

18. A scanning system for imaging an object, the scanning system comprising:
a scanning apparatus configured to transmit ultrasound signals towards an object and to receive ultrasound signals reflected from an object whereby data pertaining to an internal structure of an object can be obtained;
a location sensor for sensing a location of the scanning apparatus; and
a processor configured to determine an estimate of the location of the scanning apparatus in dependence on the sensed location and the obtained data.

19-23. (canceled)

24. A scanning system according to claim 1, in which the location sensor comprises a further positioning system configured to determine a location in one frame of reference and to transform that determined location into another frame of reference.

25. A scanning system according to claim 24, in which the further positioning system is configured to determine a transformation for transforming the determined location into the other frame of reference in dependence on one or more marker in an image captured by the scanning system.

26. A scanning system according to claim 1, configured to intersperse a plurality of scans of a first scan type with at least one scan of a second scan type.

27. A scanning apparatus according to claim 26, configured to regularly intersperse the plurality of scans of the first scan type with the at least one scan of the second scan type.

28-32. (canceled)
